(19) United States
(12) Patent Application Publication
(10) Pub. No.: US 2022/0036377 A1
(43) Pub. Date: Feb. 3, 2022

(54) DATA EXCHANGE PLATFORM FROM PERSONAL DATA PLATFORM

(71) Applicant: EMC IP Holding Company LLC, Hopkinton, MA (US)

(72) Inventors: Amy N. Seibel, Cambridge, MA (US); Thinh Lam Truong Nguyen, Medford, MA (US); Akshaya Khare, Cambridge, MA (US); Victor Fong, Medford, MA (US)

(21) Appl. No.: 16/945,480

(22) Filed: Jul. 31, 2020

(51) Int. Cl. G06Q 30/02; G06F 21/62; G06F 21/60; G06Q 30/06; G06Q 30/08

(52) U.S. Cl. CPC G06Q 30/0201; G06F 21/6227; G06F 21/6245; G06Q 30/0609; G06Q 30/0607; G06Q 30/08; G06F 21/604

(57) ABSTRACT

A data exchange platform is disclosed that allows users to share personal data in a controlled manner. An auction house allows data consumers and users to submit policies and dataset metadata. The auction house can automatically identify matches between the data consumers and the users. For accepted matches, the data is shared as specified in the relevant policies. Users retain control over their data and are able to share data as desired. Users also receive rewards for use of their data.

### FIELD OF THE INVENTION

Embodiments of the present invention generally relate to data platforms and data exchange. More particularly, at least some embodiments of the invention relate to systems, hardware, software, computer-readable media, and methods for data platforms configured to give users control over their personal data and to exchanging or accessing data from personal data platforms.

BACKGROUND

The number and types of devices that connect to the Internet is growing at a rapid rate. This growth is accompanied by an ever-increasing amount of data. Much of the data is personal or individual data that is regularly generated as users access services and retailers online. In addition to the data generated by activities such as browsing, online retail, and social media, smart devices such as health monitors and security systems also generate personal data almost every day.

The data generated by these activities, which is often personal in nature, is often owned by a corresponding entity rather than the individual. Online retailers, for example, own the purchase histories of their customers and often store other personal information. The makers of smart devices or services that use smart devices often provide an interface that allows the data generated by those devices to be collected and analyzed. In order to use online services, in fact, individuals often relinquish control of their personal data.

Consequently, users are often unable to ensure or control their personal data and users cannot always control who their data is shared with. Further, the inability to control their own data prevents users from ensuring their privacy, hinders their ability to share data with trusted recipients, and impedes users from monetizing their data.

As individuals become more concerned with their privacy and as laws such as GDPR (General Data Protection Regulation) become more prevalent, there is a need for a way to protect personal data. Protecting personal data, however, may have some consequences. More specifically, the need for data does not disappear if personal data is unavailable. In order to perform activities such as research and marketing, personal data is usually required. Unfortunately, the models in use today (e.g., providing a service or hardware that benefit the user in exchange for the user's data) cause the users to lose control of their data.

In addition, users are not always adequately or fairly compensated for their data. For example, once a user relinquishes their data to an entity, that entity typically profits by sharing or selling that data to other entities. Systems and methods are needed that allow users to keep control of their personal data while, at the same time, facilitating legitimate purposes such as research and marketing.

### BRIEF DESCRIPTION OF THE DRAWINGS

In order to describe the manner in which at least some of the advantages and features of the invention may be obtained, a more particular description of embodiments of the invention will be rendered by reference to specific embodiments thereof which are illustrated in the appended drawings. Understanding that these drawings depict only typical embodiments of the invention and are not therefore to be considered to be limiting of its scope, embodiments of the invention will be described and explained with additional specificity and detail through the use of the accompanying drawings, in which:

FIG. 1 illustrates an example of relationships between users, service providers, and personal data;

FIG. 2 illustrates an example of a data platform that allows users to control their own personal data;

FIG. 3 illustrates an example of a method for aggregating personal data from data sources including service providers;

FIG. 4 illustrates an example of a user interface associated with a personal data platform;

FIG. 5 illustrates and example of localized compute in a personal data platform;

FIG. 6 illustrates and example of systems and methods for controlling access to personal data and to granting leveled access to service providers;

FIG. 7 illustrates an example of authorizing access to personal data including in face-to-face situations;

FIG. 8 illustrates an example of a data exchange platform configured to match data consumers with users such that the users can share data with the data consumers;

FIG. 9 illustrates an example of data sharing or a data exchange between one or more users and one or more data consumers; and

FIG. 10 illustrates an example of a method for sharing data.

### DETAILED DESCRIPTION OF SOME EXAMPLE EMBODIMENTS

Embodiments of the present invention generally relate to data exchange platforms, personal data platforms, controlling access to personal data, and sharing or exchanging personal data. More particularly, at least some embodiments of the invention relate to systems, hardware, software, computer-readable media, for data platform operations including auction operations, sharing operations, matching operations, selling operations, data exchange operations, aggregation operations, storing operations, access control operations, control operations and the like or combination thereof.

In general, example embodiments of the invention relate to a data exchange platform that allows data consumers (e.g., research organizations, marketing organizations, businesses) to obtain personal data from individuals or users that store their personal data in their own personal data platform. The data exchange platform may ensure that users are aware of the data being shared or obtained. In addition, the exchange platform ensures that consent is obtained from the users. Embodiments of the invention allow a data consumer to obtain access to personal data based on data sharing policies established by the users and/or based on purchase policies established by the data consumers.

Individual users to establish share policies in accordance with their personal preferences. In addition, users may share their data with any data consumer that meets or satisfies the users' criteria. This may be reflected in the share policies. For example, a user may share data with more than one data consumer or may select a data consumer on factors that may or may not include price. Data consumers establish data purchase policies based on their need. Embodiments of the invention match data consumers with users based in part on the share and data purchase policies. Matching data consumers with users allows the data consumers to gain access to personal data in a way that complies with the policies of the users and in a manner that allow users to be compensated for their personal data. At the same time, embodiments of the invention enable a person to not share their data. The data exchange platform achieves the goal of enabling access to personal data while also preserving the privacy and control of users over their own personal data.

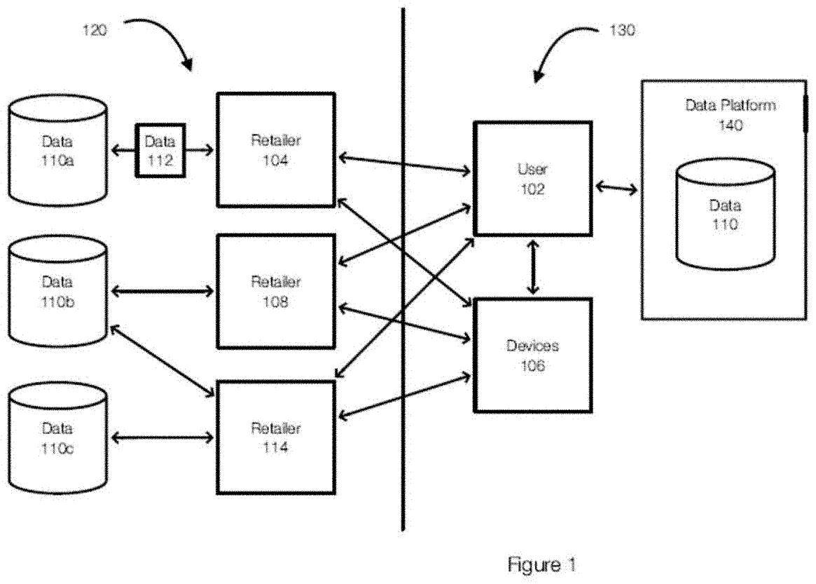

Before discussing embodiments of a data exchange platform and operations associated with the data exchange platform, an example of a personal data platform and associated operations is discussed with respect to FIGS. 1-7.

A personal data platform allows users to control and ensure their privacy, share their personal data with trusted recipients, monetize their data, and receive services from new vendors. The personal data platform can extend to data generated by smart devices, online activities and services, or the like. A data exchange platform connects data consumers with users in a manner that allows users to control and monetize their personal data.

The personal data platform is configured to provide users with control over their personal data. The data may be stored on privately owned infrastructure (e.g., the user's infrastructure) or in a remote location such as the cloud. In one example, personal data stored in the cloud (and in the local infrastructure) may be in an encrypted form such that the cloud provider does not have access to the user's data. In addition, the personal data platform provides compute capabilities that allows individuals to consume software services without sharing data with a service provider. In addition, the personal data platform provides multi-level sharing, which allows individuals to control what data is shared and to control how much data is shared with others.

FIG. 1 illustrates examples of relationships that exist amongst data, users, service providers, and other entities. Generally, FIG. 1 illustrates relationships between service providers 120 (represented by retailers 104, 108, and 114) and users 130 (represented by user 102). The service providers come in different varieties and are often associated with different types of data. A service provider such an online clothing retailer, for example, may collect and store data that is distinct from an online medical provider or from a retailer that is associated with user devices.

A data consumer is another example of a service provider. A data consumer, by way of example only, is typically an entity that is interested in consuming personal data for purposes, which may include but are not limited to, marketing or research.

FIG. 1 illustrates data 110a, 110b, and 110c. The data of the user collectively is represented as data 110 stored in the data platform 140. In FIG. 1, each service provider 120 may store their own data. The retailer 104 may store the data 110a, the retailer 108 may store the data 110b, and the retailer (e.g., a data consumer) 114 may store the data 110c. The data 110a, 110b, and 110c is generally representative of data collected and/or owned by the service providers 120. However, each service provider typically stores their own data as illustrated in FIG. 1.

Embodiments of the invention give users control over their data such that the data 110a, 110b, and 110c may begin to decrease in amount, relevance, and/or timeliness (the data may be outdated). The most current and relevant data is stored in the data 110. At the same time, some interactions between the user 102 and the service providers 120 may result in a service provider having access to and storing personal data. For example, a user may provide a medical provider with specific data such as blood pressure readings, current prescriptions, or the like.

In FIG. 1, the user 102 is associated with the data 110a and often engages in interactions with the service providers 120 that generate new data. As a result, the data 110a continually grows or is continually updated. For example, the user 102 may purchase products from an online retailer 104. This interaction between the user 102 and the retailer 104 may result in data 112 associated with the transaction. The data 112 may be added to the data 110a that the retailer 104 already has. The data 110a may include information about the product purchased and may include information about how the user 102 arrived at the online retailer 104 and the like. The data 110a may contain data about previous purchases, previous products that were placed in a cart but not purchased, and the like. Because the retailer 104 is presumed to own the data 110a, the control of the user of the data 110a is limited.

The user 102 may also be associated with devices 106. These devices 106 may include, by way of example only, a health monitoring device, a security camera, smart devices, IoT (Internet of Things) devices, or the like. These devices 106, in addition to being associated with the user 102, may be associated with a retailer 108 or other service provider. In one example, the retailer 108 may collect data generated by the devices 108. The data generated by the devices 106 and collected by the retailer 108 is also included in or represented by the data 110. For example, data generated by a smartwatch or an app running on a smartwatch may be collected by the maker of the smartwatch, the maker of the app, or both. Further, this data may be made available to other apps or service providers. Each of the service providers 120 may be associated with different devices 106.

FIG. 1 further illustrates a retailer 114, which is another example of a service provider that may use or access the data 110b and/or store their own data 110c. In this sense, the retailer 114 is also a consumer of data stored by other service providers. For example, a doctor may desire to review health data generated by a wearable medical device. A home security service may review data generated by a security camera or system. The retailer 114 may be a research or marketing entity.

By way of example and not limitation, FIG. 1 illustrates many relationships between users, service providers, devices, and data. There may be other entities that have interest in the data 110a, 110b, and 110c. The service providers 120 or more specifically the retailers 104, 108 and 114 in this example control or own, respectively, the user data 110a, 110b, and 110c.

Embodiments of the invention allow the user to aggregate the data stored by the service providers and place the data 110 under the user's control. Once aggregated, the personal data platform 140 enables the user 102, for example, to control the data 110 and control access to the data 110.

As previously stated, the data 110 is similar to the data 110a, 110b, and 110c. Even if the data 110a, 110b, and 110c exists when embodiments of the invention are implemented by the user, the data 110a 110b, and 110c may become more limited in scope over time at least because the user 102 is enabled to take control of the data 110 that has been aggregated or accumulated by the user and stored in the data platform 140.

As previously stated, data is conventionally owned and stored by each of the service providers 120 based on their use case. A bank may store financial data, a credit card company may store purchase and payment history. A health device company may store health information such as daily steps, heartbeats, or the like. As illustrated in FIG. 1, because the data 110a, 110b, and 110c is stored by the service providers 120, the privacy of the user 102 may be compromised at least because administrators or other persons associated with these service providers 120 may have access to personal data. The user 102 may also be subject to security breaches and the user's data may be shared with other institutions (including other governments) without their consent.

These concerns are not alleviated when the data 110a, 110b, and 110c is stored in the cloud. Administrators of the cloud service provider, in addition to persons at the retailers, may have access to the data 110a, 110b, and 110c and the user still does not have control of the data or of their privacy.

When the user consumes services from a service provider, the service provider may need some personal data. A health inference service provider may need health telemetry data. Once the data is shared with the service provider, the user loses control of that shared data. Further, many service providers may use cloud compute services to process personal data. This type of model may introduce privacy and/or control problems. The personal data, when in memory, may be accessible to the cloud service provider.

This concern is alleviated by embodiments of the invention, which allows compute to occur at the data platform 140. This may allow inferences or results to be generated from the user's data without providing the actual data to the service provider.

Embodiments of the invention thus relate to a data platform that allows a user to control their data, control access to their data, and the like. Embodiments of the invention further relate to copying data from the storage of service providers to the storage of the user. Embodiments of the invention can run on privately-owned infrastructure and/or the cloud. When using cloud infrastructure, the user may not need to setup or maintain their own infrastructure. Alternatively, embodiments of the invention may be embodied as a turn-key appliance. The data may be encrypted in any of these embodiments to further strengthen privacy.

The data platform may reduce security risks and improve privacy. In addition, the data platform provides different mechanisms to consume services provided by service providers and provide security for individuals. In addition, embodiments of the invention can execute in a single tenant model or a multi-tenant model.

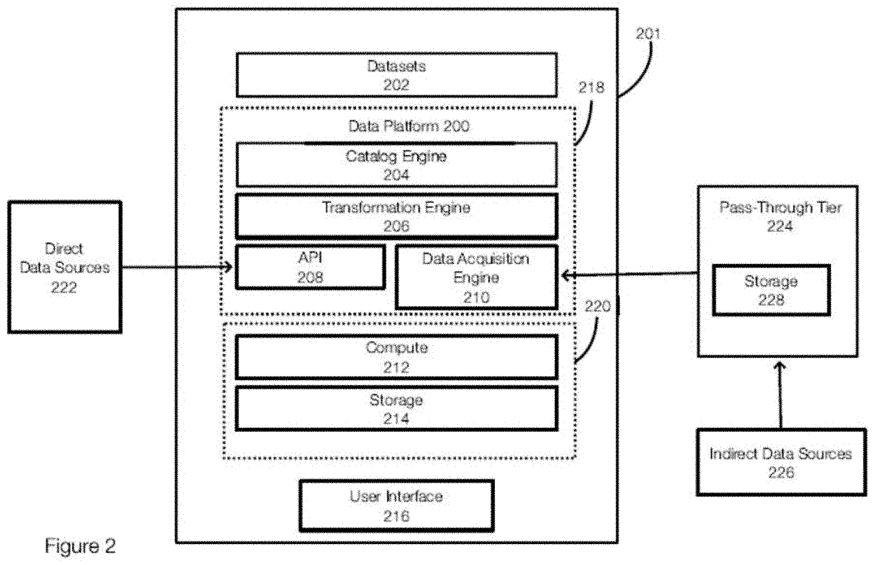

FIG. 2 illustrates an example of a data platform that may be implemented in private infrastructure and/or in an infrastructure such as the cloud (e.g., a datacenter). The data platform 200 is typically configured to acquire data from data sources such as direct data sources 222 and indirect data sources 226. Service providers (e.g., the service providers 120 illustrated in FIG. 1) are examples of data sources from which personal data is retrieved and ingested into the data platform 200.

Examples of the direct data sources 222 include, but are not limited to, smart home devices, home security systems, health monitors, baby monitors, and the like. The direct data sources 222 may be connected to the same local area network as the data platform 200. As a result, the direct data sources 222 can connect to and directly communicate with the data platform 200. In one example, the direct data sources 222 may communicate via an application programming interface (API) 208. The direct data sources 222 are thus configured to transmit data to the data platform 200 through the API 208.

As described in more detail below, the data received into the data platform 200, which may be running on infrastructure 201, may be transformed by a transformation engine 206 and catalogued by a catalog engine 204, which are both included in embodiments of the data platform 200. The transformed and/or cataloged data is stored as datasets 202, which may be encrypted.

Data sources such as the indirect data sources 226 may not be on the same network as the data platform 200. These indirect data sources 226, due to various restrictions such as firewalls, may need a pass-through tier 224. The pass-through tier 224 is used to receive and/or transmit data to the indirect data sources, which may also be service providers. In one example, the data platform 200 and the indirect data sources 226 may agree on end-to-end encryption such that the data cannot be read when stored, for example temporarily in the storage 228, of the pass-through tier 224.

Examples of indirect data sources 226 include service providers such as online retailers, banks, hospitals, or the like or combination thereof.

The indirect data sources 226 may be capable of sending data to the pass-through tier 224 on their own initiative or based on a request from a user. The request may be generated through a user interface 216. Data acquired from the indirect data sources 226 may be acquired or updated on request, at scheduled intervals, or the like. Further, the same security protocols applied to the local environment of the data platform 200 may also be applied to the pass-through tier 224.

For example, the indirect data sources 226 may write data to the storage 228 when requested, per a predetermined schedule, or in another fashion. The data platform 200 may include a data acquisition engine 210 that is configured to retrieve the data from the storage 228. In this manner, the data from the indirect data sources 226 is ingested into the data platform 200. In one example, the data acquisition engine 210 includes an API. The data acquisition engine 210 may initiate communication with the pass-through tier 224 and/or respond to a notification or request from the pass-through tier 224 or the data source that data is available for retrieval or transmission.

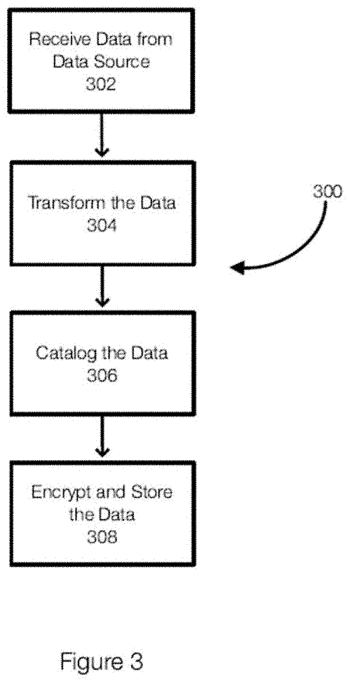

FIG. 3 illustrates an example of data aggregation when ingesting or aggregating data from data sources. While a user may interact with the data platform 200 via a user interface to manually aggregate data, the data aggregation from the various data sources may also be automated. For example, once a data source is identified and the communication method is established, the actual retrieval of the data may be automated.

In the method 300, the data is received 302 from a data source such as a direct data source or an indirect data source. Although embodiments of the invention allow for multiple data transmission mechanisms (e.g., UDP, TCP, HTTP, message bus, pub/sub, or the like), the data may be encrypted end-to-end during the transmission process.

After receiving the data, the data is transformed 304. The transformation may be dependent on a data-type of the received data. However, embodiments of the invention can handle any data type or can be configured to handle any data type. Further, the data may be decrypted prior to transformation. For example, pictures may all be transformed into a format such as JPEG or into a custom format. Text may be transformed into XML data or text data. Transforming 304 the data may also include compressing the data after conversion into a pre-determined format. While data received by the data platform may be structured or unstructured, the transformation process typically results in structured data.

After the data is transformed 304, the data is cataloged 306. Cataloging 306 the data may include generating additional metadata that describes the data or tagging the data. Data can be categorized and tagged. Information from a blood pressure cuff, for example, may be tagged or categorized as health data and may include additional tags that are more precise such as blood pressure measurement, systolic reading, diastolic reading, or the like. Different metadata designs can be used. For example, tree-based structures of categories and sub-categories may be used. Tag-based metadata may also be used. In addition, automations can be configured to auto-catalog incoming data from each of the data sources.

In one example, a plug-in based implementation is used for transforming 304 the data and for cataloging 306 the data. A plugin associated with a smart watch, for example, may be configured to transform and catalog data from the smart watch. In addition, machine learning algorithms may be provided such that the transforming and cataloging processes can be automated and improved. Existing transformations and cataloged data may be used as training data.

Next, the data is encrypted and stored 308 in the datasets of the data platform.

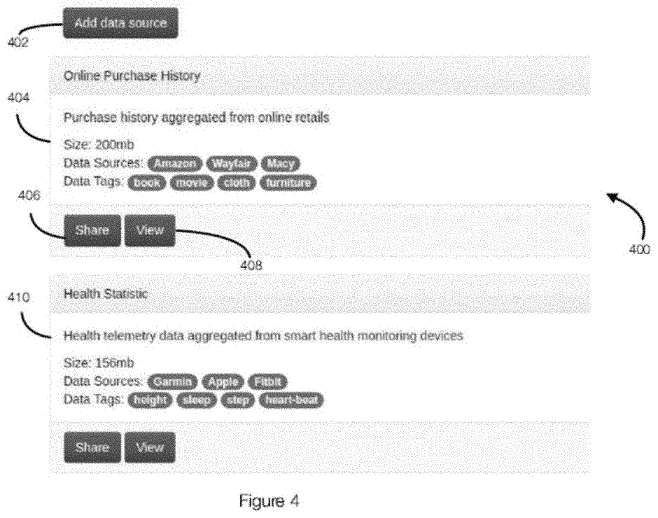

FIG. 4 illustrates an example of a user interface 400. Using the user interface 400, data can be aggregated, retrieved, or received from a data source, shared, and/or viewed. The user interface 400 is an example of allowing a user to control their data that has been stored in the data platform.

FIG. 4 includes a button 402 (or other user interface element) that starts a process of adding a data source to the data platform. When selected, the process of adding a data source may include providing a URL (Uniform Resource Locator) that can be accessed automatically or manually. For example, the data source may provide an API that can be accessed and through which data can be downloaded (directly or through the pass-through tier). For example, a user may input www.<retailer>.com\<api>, which can be used to initiate the process of acquiring user data from the data source.

FIG. 4 also illustrates data (or links to data) that has been transformed and/or categorized. The online purchase history 404 is an example of data that is categorized as online purchase history data. The data sources for online purchase history data include Amazon, Wayfair, and Macys. The data has been cataloged, by way of example only, with tags such as book movie, cloth, and furniture. The add data source 402 may allow a data source to be added to this category. Similarly, health data has been categorized as health statistic data 410. The health statistic data 410 is retrieved from data sources that include Garmin, Apple, and Fitbit. The data has been cataloged using tags such as height, sleep, step, and heart-beat.

The share button 406 and the view button 408 allow the data to be shared and/or viewed. The view button 408 may allow the user to view the data that has been aggregated. This may allow the user to make corrections or other changes. The share button 406 may allow the user to share the data with another entity. The share button 406 may also allow a user to indicate or specify how data is to be shared with specific service providers. For example, the user may select to share raw data with a doctor, but only share doctor reports with an insurance company. Thus, access to the data and the manner in which the data is shared is controlled by the user.

Returning to FIG. 2, the data platform 200 may also be associated with and run on hardware 220. The hardware 220 includes compute 212 and storage 214. The hardware 220 allows the data platform 200 to perform localized compute using the datasets 202.

More specifically, many service providers may need personal data to provide a more personalized user experience. For example, a clothing retailer may use a previous purchase history to obtain information such as size, favorite or preferred style, preferred color, or the like. This may allow the clothing retailer to recommend products to the user.

Embodiments of the invention allow this type of analysis to be performed locally. More specifically, the user is not required to share any data with the service provider. This is achieved, in effect, by bringing compute to the data platform 200 rather than sending data to the service provider for compute purposes.

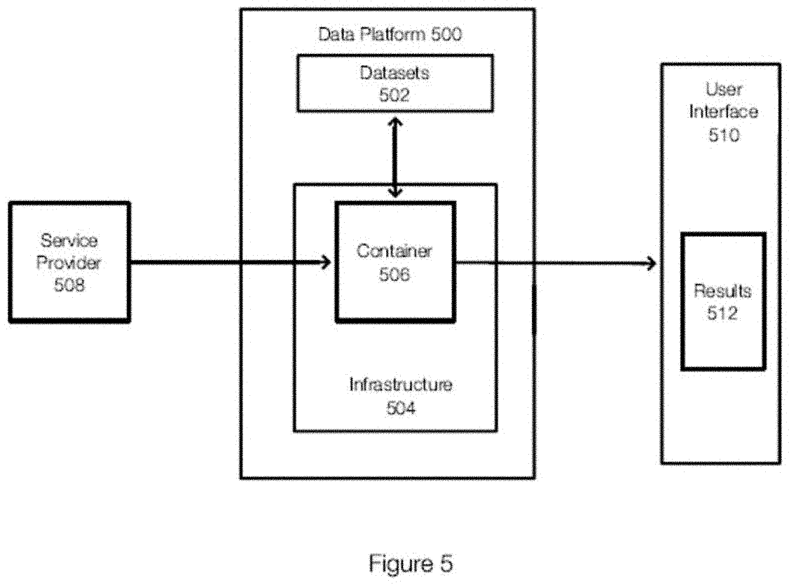

FIG. 5 illustrates an example of localized compute. FIG. 5 illustrates a data platform 500 that is associated with a user. The data platform 500 stores or has access to datasets 502, which stores personal data of the user that has, for example, been transformed and cataloged.

In this example, the service provider 508 may provide the data platform 500 with their services in a pre-defined format, such as container 506. The container 506 can be downloaded to the data platform 500 and installed or executed using the infrastructure 504. The container 506 can execute against the datasets 502 and present results 512 in a user interface 510 to the user. The user may allow the results to be shared with the service provider, for example through the pass-through tier or directly.

In one example, the infrastructure 504 or compute environment may be controlled. For example, the infrastructure 504 in which the container or other executable executes may not have an external network connection. This ensures that the container 506 cannot copy personal data out of the data platform 500. The service provider 508 may provide their own user interface to interact with the user. For example, a service provider can offer a notification system through the pass-through tier and/or mobile devices.

In other examples, a user interface may be provided to provide service for users using the data platform. The user interface could be hosted elsewhere, for example on a mobile or other consumer device. The service provider may also provide a user interface to run inside the data platform. As a result, embodiments of the invention provide flexibility and allow the user interface to be run in different locations and to accommodate different use cases.

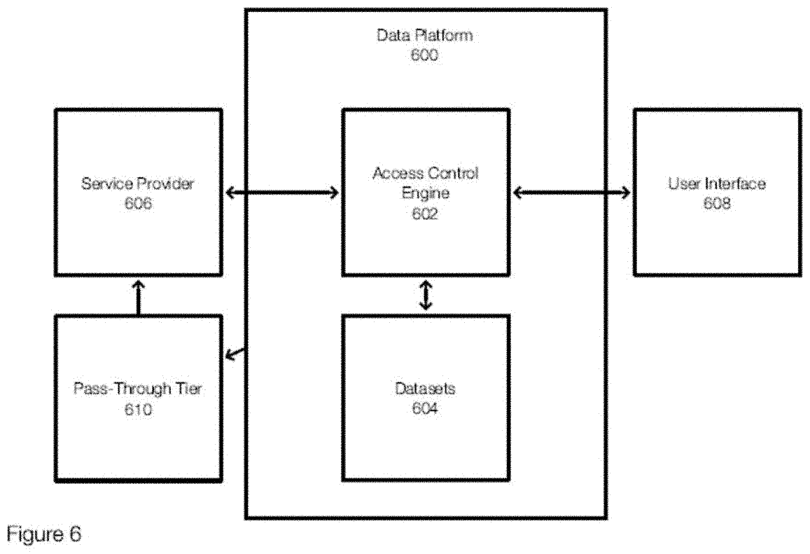

FIG. 6 illustrates an example of an access control engine configured to control a level of data access. The access control engine 602 may be accessed through a user interface. The access control engine 602 provides controls or allows the user to control how the various service providers access data. Through a user interface 608, a user can access the access control engine 602 of the data platform 600 to set controls or to set access levels on the datasets 604. Each service provider and each person the data is shared with may be controlled separately and independently of other service providers. Controls can be set based on service provider, data type, privacy levels, or the like or combination thereof. Other criteria for controlling access or for setting levels may include dates, details, size, or the like.

When the datasets or data of the user are accessed or shared, the access control engine 602 may control access by evaluating permissions or access permissions and allow access to the datasets 604 accordingly.

For example, data can be shared as raw data (the highest permission or access level) or at lower levels. For example, a patient may share raw lab results with a doctor office, but only share doctor reports with an insurance company. Although each service provider may gain access to and duplicate a part of the data, the user can set permissions and maintain full control of the personal data.

The ability to share data can also be achieved in different manners. Data transmission can be done directly from a pass-through tier to a server hosted by the service provider. In this example after evaluating permissions, the data platform 600 may send the relevant data to a pass-through tier 610. The service provider 606 may be notified that data is available and may retrieve the data from the pass-through tier 610. In this and other examples, the data is encrypted (usually with a provider-specific key) and the key to decrypt may be transmitted separately.

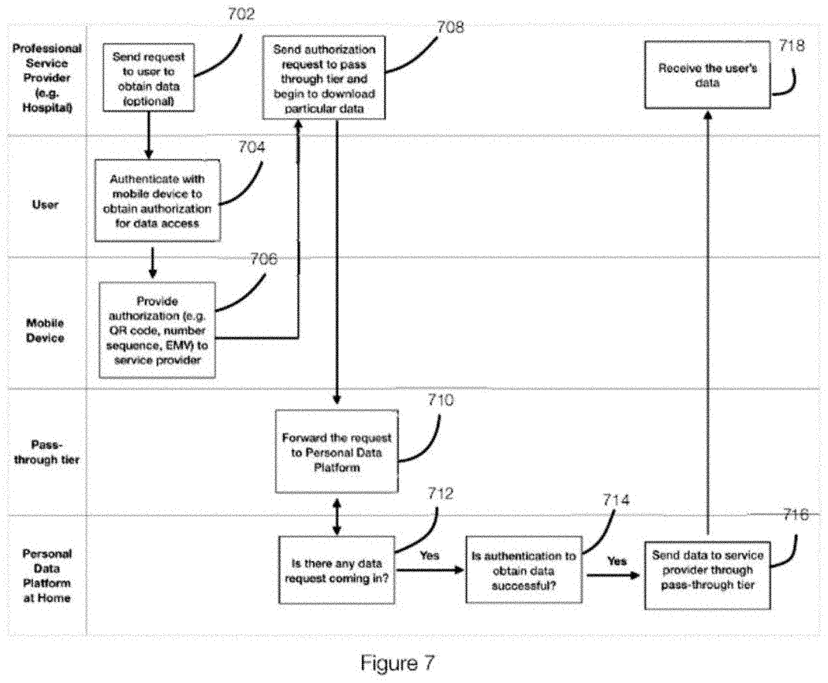

FIG. 7 illustrates another example of data transmission from a data platform to a service provider. FIG. 7 illustrates the various components and/or users and their relationships as the data is accessed and provided to a service provider. In this example, a request is sent 702 to obtain data. This may be performed using a device associated with a hospital or other service provider. The request can be sent via email, text, over Bluetooth, or the like. Next, the user may authenticate 704 with their mobile device to obtain authorization for accessing the data platform. The mobile device may provide authorization 706 (e.g., a QR code, number sequence, EMV) to the service provider (the hospital in this example). By presenting the authorization, access to the data platform may be granted. The authorization 706 may be associated with a specific service provider and may allow the data platform to enforce access levels.

Although FIG. 7 illustrates an example of a method that begins with a request from the service provider, the data owner could initiate the request as well. In addition, the order of elements set forth in FIG. 7 may be different. For example, the user may initiate a request and provide authorization to the service provider without receiving a request from the service provider. In addition, the path of the data retrieved from the personal data platform in response to the authorization may vary.

The service provider can then initiate the process to retrieve the data once the service provider has the authorization. The service provider may receive the authorization by reading the QR code, receiving the number via text or email, or the like.

The service provider sends 708 an authorization request, which includes the authorization, to a pass-through tier to begin to download specific data. The data platform may determine that a data request has been received 712 or is posted at the pass-through tier. Next, the authentication is verified 714. If the authentication is successful or verified, the requested data is retrieved from the data platform and the retrieved data, usually in an encrypted form, is sent 716 to the service provider through the pass-through tier. The service provider then receives 718 the user's data.

As previously stated, the path of the data retrieved from the data platform may vary. The data may pass through the mobile device (or other user device) as part of the pass-through tier. For example, a user may share data with a retail store in which the user is present. However, the data could also go directly from the pass-through tier to cloud services provided by the service providers.

This example demonstrates that devices such as a smart phone can be used as a transmission medium or used to facilitate the transfer of data through a peer-to-peer transfer mechanism in a face-to-face scenario (e.g., the user is at the hospital and wants to give the provider certain data). In this example, the user, who is entering a hospital, can provide permission to share health related data. In one example, the service provide may agree to allow data to be stored by the user rather than with the hospital. For example, data generated by medical devices used when a user is a patient in a hospital may be stored by the hospital or in the data platform of the user. The rules may be governed by applicable regulations.

In this example, the mobile device does not actually store the data (although the data may be stored temporarily), but acts as a transmission medium to link the user with the data source. Data will not be decrypted or viewed inside the mobile device. The data is only decrypted and viewed at the destination. The data path is thus from the data platform to the pass-through tier-to the mobile device, and to the service provider receiver (e.g., using Wi-Fi or Bluetooth).

Instead of storing personal data with a third party vendor or cloud infrastructure provider (although this is contemplated by embodiments of the invention), the personal data may be stored in privately-owned infrastructure (such as a desktop or home edge-station). This not only provides additional data control, but also increases the security measure by not utilizing third party infrastructure.

In addition, instead of transmitting data over to service providers (e.g. hospitals) and risking personal data being duplicated, this invention instead brings compute to the data by offering a standardized compute environment. In other words, the computation/inference service will be executed on private infrastructure instead of in the cloud or in the infrastructure of the service provider. Because the data is never transmitted outside of the data platform, and the compute is executed within the platform, security risk decreases.

Thus, instead of transmitting data to the service provider, embodiments of the invention bring the service to the data platform for execution. Because the user owns the infrastructure that executes the service, additional restrictions can be applied to the environment to further reduce security risk. For example, the execution environment might not have a network connection, so that the data would not be duplicated or sent back to the platform it originated on. More specifically, even if the execution environment prevents the user data from being transmitted out of the personal data platform, the execution environment may allow inferences generated by the service to be transmitted. Further, there is sufficient connectivity during execution of the service such that the service can use the data stored in the personal data platform to generate the inferences. More specifically, the inference could be computed on the personal data platform, in the on-premise environment. In this example, the inference model (e.g., a container or other executable) is transmitted to the personal data platform from the service provider. This allows the inference model to be executed using the user's infrastructure and gives the user more control over the user's data. In one example, only the inference is returned to the service provider. Generally, the user is able to control what type of data is transferred back to the service provider.

A pass-through tier addresses various firewall issues, so that other cloud services or mobile devices can access data from a personal data platform hosted in a private network.

The aggregation of personal data from multiple sources, on a user's personal infrastructure, is disclosed. When aggregating data, the data may be categorized, classified, and or tagged by content type (and other attributes). Classification and/or tagging could also be done automatically. Data could also be shared based on the classification, category, tag type, service provider, size, and other criteria.

The use of devices (e.g., mobile devices, IoT devices and other client devices) as a data transmission medium is disclosed. In this context, a data transmission medium refers to a data transfer hub that allows for the data source and recipient to be associated in real-time, and in the location that the user needs (e.g. to pass personal healthcare data from a patient to a doctor in real-time, during an appointment).

The ability of a user to control the sharing of their data at a granular level is disclosed, as is the user interface that will enable uses to do so on private infrastructure. This covers which types of data will be shared, who it will be shared with, and what portions of that data will be shared.

For example, a person generates a large amount of health data throughout her lifetime, such as doctor reports, lab results, health telemetry from smart devices, scan images, etc. These data can serve as input to continuously monitor the health of the patient, and to diagnose new problems when they appear.

Instead of trusting a third party vendor (such as a hospital, health monitor provider, etc.) to store this important data, individuals store this data on infrastructure of her own choosing.

As new telemetry and data (such as heartrate, body temperature, doctor reports, lab results, etc.) are generated, each device acts as a data source that feeds data into this personal data platform.

When the patient needs to get insurance quotes (for example, life insurance, health insurance, or driver insurance), each insurance company may provide inference services that can execute on this data platform to make inference based on these data. For example, an internet-connected car or connected vehicle could be uploading driving data that is captured and moved into the personal data platform. When the car owner needs to obtain/renew auto insurance, the insurance inference model could be executed on the data set (data collected from the connected vehicle). The inference may be used to provide an insurance quote based on the user's actual driving data. In addition, the user has control of whether to share this data or allow the data to be used for generating inferences. The user can opt into or out of inferencing and data sharing.

In another example, a traveler may need to be admitted into a hospital in a foreign country or in a location that may not have any data about the user. Embodiments of the invention allow this user to share data using the patient's mobile device (with user consent) and the data can be transferred to the hospital, so that the hospital can gain access to the patient's medical history. The patient could also share certain health information with a loved one or a caregiver. Thus, the personal data platform allows the user to share data from locations geographically distant from the user's infrastructure and using different networks to transfer the data.

As discussed above, the personal data platform allows the user to maintain control of their personal data. However, entities such as research organizations and marketing organizations may still need access to the data. Further, some individuals may be willing to share their personal data in exchange for some form of reward or compensation such as cash, discounts, membership status, credits, access to products or services, or the like or combination thereof.

A data exchange platform allows data consumers (e.g., marketing organizations, research organizations, businesses) to gain access to personal data on the user's terms. The access to the personal data may be controlled according to sharing policies that are established by the users themselves. The personal data of an individual can be shared in part, in whole, in a granular manner (e.g., partial access to a data set), or the like. The sharing policy is robust and can be used to control how the data is shared.

A user, from the perspective of the data exchange platform, may be a person that generates personal data such as a person that purchases products from an online retailer, a person that wears a health device, a person that owns a security camera, a person that has an online bank account, or the like.

A data consumer is an example of an entity that is interested in consuming personal data from users or individuals. The interest in consuming personal data may be related to marketing purposes, research purposes, or the like. For example, a marketing research firm may be interested in predicting trends of fitness goods and merchandise. A pharmaceutical company may desire to understand the demographics of patients with a specific disease. An investment company may want to predict individual investor behaviors. A security company may want to market new products to homeowners that already own a home security system.

There are numerous reasons for desiring access to personal data. However, once data is protected by, for example, a personal data platform, users may not have an incentive to share their data voluntarily. Embodiments of the invention allow users to share their data without sacrificing their privacy for the quality of service desired. Embodiments of the invention allow users to share data in a manner that is controlled by the user. Users are able to define (or not define) sharing polices that can be data specific, data consumer specific, or the like.

Embodiments of the invention allow users to share data that is protected or stored in a personal data platform. By giving users control of their own data, users are better able to monetize their own data and to control how the data is shared. Storing data in a personal data platform places the user in control of their own data.

When a personal data platform is available, data from various devices and service providers are streamed directly to or stored in the user's personal data platform instead of being stored by other service providers.

Embodiments of the invention allow users to share personal data with users in exchange for some form of compensation or reward. Users are able to implement different levels of data sharing policies based on privacy concerns.

In some examples, an auction house is provided to match data consumers with users. However, the auction house does not gain access to or visibility into the personal data of users using the auction house. Further the compute orchestration of training or analytics can be based on individual preferences.

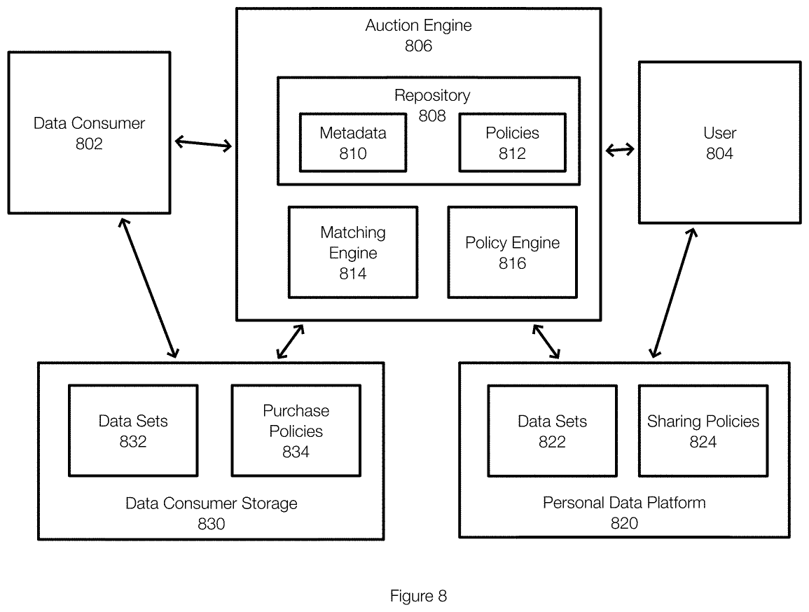

FIG. 8 illustrates an example of a data exchange platform. The data exchange platform illustrated in FIG. 8 includes an online auction house, represented by auction engine 806, which may be implemented as a web site that is accessible to data consumers (represented by data consumer 802) and users (represented by user 804).

In some examples, the consumer 802 may also be an auction provider or implement the auction engine 806. This user 804 may be made aware of whether a data consumer is also running or providing the exchange platform or the auction engine 806. Data consumers may have different (e.g., profit, non-profit, educational) types.

In some examples, the user 804 may be any individual, entity, or organization that is sharing data or allowing access to data via the auction engine 806. Thus, the data consumer 802 may be a user in some embodiments. Further, data providers (e.g., providers that have databases of data that may pertain to individual users or groups of users or simply multiple users) may also be users and use the auction engine 806 to share their data or to allow access to their data. Thus, the auction engine 806 may interact with different types of users and/or different types of data consumers.

The auction engine 806 may be accessible via a user interface that allows the data consumer 802 and the user 804 to interact with the auction engine 806. Interactions may include uploading data/metadata, searching, matching, selling, posting, or the like or combination thereof.

The auction engine 806 performs the general task of matching data consumers with users. This is achieved, by way of examples, by matching the data purchasing policies of the data consumers with the data sets and/or sharing policies of the users. For example, a user may upload metadata that describes a dataset. The metadata may be uploaded in a standardized manner to facilitate machine review or machine matching. The description set forth in the metadata 810 can be compared, by a matching engine 814, with policies 812 including data purchasing policies. A data set related to blood pressure readings for a 30 year old male may be matched to a data purchase policy that identifies a need for blood pressure readings from candidates include males from 25-35 years of age. The comparison may also account for characteristics of the data set such as age, length, update date, and the like.

Once a match is discovered (or at the same time), the sharing policy of the user can also be compared to the data purchase policy. This allows the data consumer to be aware of the requirements and other requirements of the user regarding the dataset. If agreeable to both the data consumer and the user, the dataset may be acquired in accordance with any terms that may be agreed upon or that may be specified in the sharing policy. If necessary, the auction engine 806 may facilitate the ability of a data consumer and a user to negotiate. Once the match or agreement is finalized, the data is shared or exchanged in accordance with the policies.

In more detail, the user 804 is associated with a personal data platform 820, which is an example of the personal data platform described with respect to FIGS. 1-7. The personal data platform 820 may store datasets 822. The datasets 822 are representative of the personal data of the user 804 and may be stored or accessed in different manners. For example, each device of the user 804 that generates personal data may be associated with a different dataset. Social media data may be stored as a dataset and may be further divided by app, website, provider, or the like.

The datasets 822 may be associated with sharing policies 824. In one example, each of the datasets 822 may be associated with one or more sharing policies 824. The sharing policies may be specific to a service provider or other reason. Although the sharing policies 824 are illustrated in the personal data platform 820, the sharing policies 824 can be integrated into or stored at the auction engine 806 in the repository 808. Thus, each user may have an account with the auction engine and the sharing policies may be stored as policies 812 (user-specific in in one example) in a repository 808. It may also be possible for the auction engine 806 to provide a mechanism that allows a user to simply select a sharing policy level or offer default policies. The data consumer 802 may also have an account with the auction engine 806.

However, because the auction engine 806 does not have access to the datasets 822, the sharing policies are typically enforced by the personal data platform 820.

As previously stated, a sharing policy 824 can be created for each dataset. By way of example only, the sharing policy 824 may allow a user to define or provide the following criteria in a standardized form:
1. Reward selection
   a. Reward type
   b. Reward value
2. Sharing Level
   a. Including or excluding personal identity and contact information
   b. Raw data vs. Processed data
   c. Data source (e.g. only certain apps)
3. Length of authorization
   a. Permanent (unless withdrawn)
   b. A defined period of time (e.g. a week, month, or year)
   c. Upon request
4. Execution
   a. Execution on individual-owned infrastructure vs infrastructure owned by data consumer
   b. Whether the sale needs manual review and approval
5. Reselling restrictions
   a. Whether the data consumer can resell raw data or insights generated from personal data
   b. Whether the data consumer is a nonprofit or for-profit, is in a certain industry, will use the data for medical research, marketing research, etc.
   c. The geographic region of the data consumer
   d. Whether the 3^{rd} party vendor (e.g., a data consumer) is validated/trusted by the auction house
      i. Availability and trustworthiness of identifying information for the data consumer, by type (e.g. attestation, SSL certificates, 2-factor authentication, or the like or combination thereof
      ii. Prior data owner comments and ratings (did the data owner have a bad experience with the data consumer? Did the data owner receive rewards time/as promised by the data consumer?)

The sharing policy 824 presented above is an example sharing policy. Embodiments of the invention are not limited to the criteria set forth therein. Additional criteria or less criteria may be specified. In one example, the sharing policies 824 may be standardized to facilitate the auction of data or to facilitate the data acquisition process. A standard sharing policy facilitates machine review of data that may be acquired by a data consumer. The data consumer 802 can agree to the terms of the sharing policy, for example, in a smart contract.

Once the sharing policy 284 is completed in the personal data platform 820, metadata for a dataset 822 may be uploaded to the auction engine 806 and stored in the metadata 810 in the repository 808. Thus, the auction engine 806 stores, for each dataset the user decides to share, metadata of the dataset and a corresponding sharing policy.

The metadata 810 of a dataset may include information that describes the data set. The metadata 810 may include enough information for a data consumer to determine whether the associated dataset is worth acquiring. An example (embodiments are not limited to this example) of metadata may include:
1. Size of Dataset (e.g., 10 MB)
2. Category and Format
   a. The category may be health data or even more specific such as vital signs. The categories can be nested or hierarchical. The form may be standardized or specified.
3. Description of individual with/without identifying and contact information
   a. The description may identify sex, allergies, medial history, specific diseases, or the like.
4. Length/age of the Dataset
   a. The dataset may be x days old.
5. Update date of the Dataset
   a. E.g., the dataset was updated in the last 30 days or x records were updated in the last 30 days
6. Date Range of the Dataset
   a. This may include range covered, time of day of measurements, or the like.

The foregoing example of metadata may be specific to a category. Different categories of data may be associated with different metadata. For example, the data needed to perform research related to blood pressure or other medical condition may not be relevant with respect to metadata describing music trends or the like. Thus, each category may be associated with different metadata. In addition, the user may or may not provide all of the metadata. This may have an impact on the reward however and may impact the decision of the data consumer.

Once the metadata is received and stored as metadata 810 in the repository, the dataset associated with the metadata may be listed as available for sharing. The user 804 may access the auction engine 806 via an online portal, a desktop or mobile application, or the like to begin the process of uploading the metadata and/or the associated sharing policy. As previously stated, the auction engine 806 receives the metadata of the data sets, not the actual data. As a result, the privacy of the data sets has not been compromised.

The sharing policies 824 can also be used to specify synchronization. This allows new data and or new/updated metadata to be made available by the auction engine 806. This may also apply to data that has been acquired by the data consumer 802. The sharing policies 824 (and or a purchase contract, which may be a smart contract reflected in an online distributed ledger) may specify how the data is updated: automatically, periodically, upon request, etc.

Similarly, the data consumer 802 may establish a purchase policy for a certain category of data or for a sub-category of data. The purchase policies 834 may also be more generalized and/or standardized. By way of example only, a data purchase policy may include the following information or criteria:
1. Price per unit per dataset
   a. Discounts/coupons on products or services
   b. Cash rewards (including currency selection)
2. Dataset Category and Format
   a. E.g., vital Signs
3. Individual demographic
   a. Female 20-30 years old living in New Year City without major diseases
4. Minimum data length
   a. 1 years or more
5. Budget
   a. Only have $2000 to spend
6. Synchronization Schedule
   a. Interested in obtaining new data continuously
   b. Interested in limiting the frequency of updates to the data set (either addition of new people or updates to the same user's data)
   c. The data owner could also be compensated for each data refresh on the same data set

A purchase policy 834 may allow the data consumer 802 to automatically obtain and train with data acquired through the auction engine 806. More generally, the acquired data is used by the acquiring data consumer for purposes of the data consumer such as research, marketing, machine learning, training, etc.

With the dataset metadata, the data purchasing policy, and the sharing policy, the auction engine 806 employs the matching engine 814. The matching engine 814 is configured to automatically match data purchase policies 834 of a data consumer 802 with sharing policies 824 and/or datasets of a user 804. If a match is determined, the data can be shared automatically or may be subject to confirmation by the user 804.

While individuals such as the user 804 could deal with the data consumer 802 individually to share the data sets 822, this is not practical from the perspective of the data consumer 802, which typically requires data from multiple (e.g., millions) users. Asking the data consumer 802 to interact with users individually would take too much time and consume substantial human resources. The auction engine 806 allows these interactions to occur automatically at agreeable conditions or terms that are specified in the policies 812. The auction engine 806 allows data listings to be standardized, initializes data sharing, provides automatic negotiation mechanisms, and automates rewards. In one example, this differs from conventional service providers or consumers or auction houses at least because the auction engine 806 does not store or own the datasets themselves.

The auction engine 806 facilitates the ability of users to share data with data consumers based on sharing policies. As a result, a user 804 can list their datasets 822 on the auction engine 806 in exchange for rewards. The datasets 822 may be listed by posting the metadata and/or sharing policy with the auction engine 806. T

The user 804 can use the sharing policies 824 to describe what types of data are made available to what types of data consumers. For example, a user 804 may want to make certain data available to healthcare researchers, but not retail data consumers. The user 804 may want to share a certain subset of their datasets 822 with specific data consumer types. The user 804 can also set preferences to automatically accept rewards that meet their criteria or to manually review after each match.

As previously stated, the data consumer 802 can set purchase policies 834 to list their rewards for data, how the data is used or the purpose of acquiring the data (or inferences). The purchase policies may also set how the user will be rewarded. Many of these details are resolved by the matching engine 814. In some examples, an exact match is not required. It may be possible to generate a match based on certain criteria or based on a percentage of matching criteria. This process can be automated or subject to user approval. While both the data consumer 802 and the user 804 can make manual efforts to match the supply and demand, the auction engine 806 the provides automation to identify matches. The auction engine 806 can facilitate a process where both the data consumer 802 and the user 804 can make negotiate on the sharing or sale of data in the data sets 822.

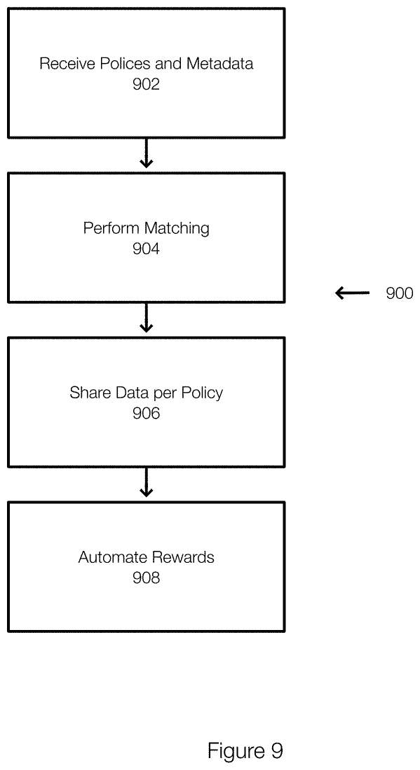

FIG. 9 illustrates a general method for enabling users to share data. Initially, an auction house (e.g., the auction engine illustrated in FIG. 8) may receive 902 polices and metadata. More specifically, the auction house may receive a data purchase policy from a data consumer and receive metadata and an associated sharing policy from a user. The auction house may thus store a large number of dataset metadata and policies in a repository.

The auction house may then perform matching 904. The matching process includes comparing the data purchase policy of a data consumer with the dataset metadata and/or associated sharing policies. In some examples, a match is found when there is less than 100% matching. The policies themselves may allow for negotiations or automated adjustments in order to secure a match. For example, a dataset may satisfy the requirements of a data purchase policy. However, the rewards may not match. In this example, an automated request may be generated to the user to determine if the reward in the data purchase policy is sufficient. Until the user approves, access is not granted. This ensures that the user has control over the data, how the data is shared, how the data is monetized, and the like.

Performing matching 904 may include, in addition to determining a match, performing other tasks until an agreement is reached between the data consumer and the user or users.

Next, the data is shared 906 per requirements of the policy. This may include performing compute in the personal data platform, performing compute at a third party infrastructure, sending the actual data to the data consumer, or the like.

The auction house may also automate 908 rewards. In other words, the auction house may ensure that the rewards specified in the policies are in fact delivered or granted. Failure to comply may have consequences, such as revoking access to the auction house (temporarily, until rewards granted, or the like).

In some embodiments, sharing 902 the data per the sharing policy and automating 908 the rewards are performed at the same time. The manner in which rewards are granted or issued may vary. A user may receive a reward for an initial set of data. Updates to that data set may result in additional rewards.

The auction house relieves the data consumer from interacting with large numbers of users individually while also ensuring that the individual users retain control of their data and share the data as they desire to share the data.

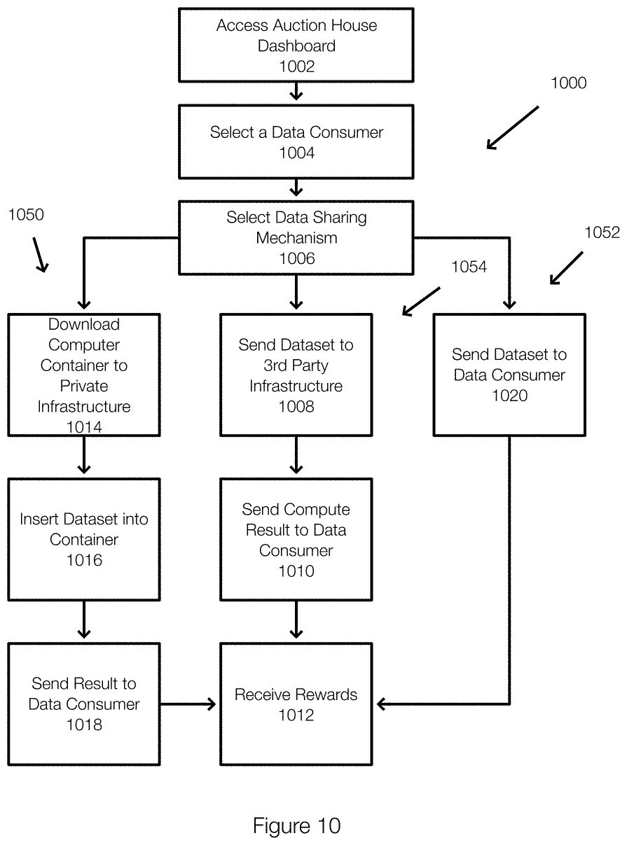

FIG. 10 illustrates an example of a method for sharing data. For example, the method 900 may include accessing an auction house (e.g., the auction engine illustrated in FIG. 8). Accessing the auction house may be performed by both the data consumer and the user. Stated differently, the auction house receives a data purchase policy from the data consumer and then receives dataset metadata and a corresponding sharing policy from the user.

The method 1000 may occur automatically after a match is made between a data consumer and the user. Alternatively, the process may be manual or partially automated. Some aspects of the method 1000 may be specified in the sharing policy associated with a dataset. Thus, once a match is made between a data consumer and a user (e.g., between a purchase policy and a sharing policy), the method may be performed automatically.

In this example, the auction house may provide a user interface such as a web page online or allow access via an app, a command line, an API, or other interface. Thus, the user may access 1002 the auction house using a dashboard or user interface. This step may be skipped, particularly when the process is automated as the transaction is authorized without further user approval or review. Further, the policies and/or metadata may already be present on the auction house.

Next, a data consumer may be selected 1004. This step may also be automated and accomplished when a match is determined. The policies may allow a match to be automatically approved. Thus, the selection of the data consumer may have already occurred when a match was determined. The selection of a data consumer is an example of performing matching by the auction house.

Next, a data sharing mechanism is selected 1006. The method 1000 illustrates three alternatives: sharing via private infrastructure 1050, sharing via 3^{rd} party infrastructure 1054, or direct data transmission 1052.

When sharing via private infrastructure 1050, a container (or other executable) may be downloaded 1014 to the private infrastructure of a personal data platform. As previously stated, the personal data platform provides a compute environment that is controllable. The personal data platform can enforce a sharing policy such that the actual data does not leave the personal data platform. Rather, results, learning, or inferences generated by the container may be permitted to leave the personal data platform.

Once the container is downloaded, the relevant dataset is inserted 1016 into the container or otherwise made available. Compute is performed (this may include training for machine learning or other analysis). The result or inference is then transmitted 1018 to the data consumer. This process can be performed once, periodically, as the data is updated, or in accordance with preferences set forth in the relevant polices associated with the match.

When sharing via 3^{rd} party infrastructure 1054, the dataset is sent 1008 to 3^{rd} party infrastructure (e.g., the cloud or a cloud provider). This provider may have an agreement with the user and, in addition, the data may be encrypted. Compute is performed at the cloud provider and the result is transmitted or sent 1010 to the data consumer. The third party may also be trusted by the data consumer. In one example, the auction house may function as the third party. Because the data consumer and the user already have an existing relationship with the auction house, the auction house may also provide compute related services. The auction house would, in this example, not share the actual data with the data consumer, but only share the results. The auction house may also provide a secure compute environment, ensure that transmissions are encrypted and secure, and provide protection for the datasets, the computed results, or the like.

In the direct transmission sharing mechanism 1052, the dataset is sent 1020 directly to the data consumer. The dataset is typically transmitted in a secure manner (e.g., encrypted and/or compressed).

In each of these cases and typically after the data is shared, the rewards are received 1012 by the user.

In some examples, the user or data owner may have the option of withdrawing consent going forward. This may result in a refund if access is prevented in disagreement to a previous arrangement.

In some embodiments, data consumers are verified. This may prevent entities with the wrong intention from accessing the datasets of the users. The auction house may provide a verification method such as attestation, SSL certification, prior registrations, or the like. Users may also be verified to help prevent, for example, false or fake data from being made available in the auction house.

In some embodiments, data consumers may compete with other data consumers for access (e.g., exclusive access) to certain datasets. For example, a fashion company may have a strategic desire to prevent other clothing companies from accessing a certain demographic or certain age group.

In this situation, the data consumer may be willing to pay a higher price for exclusiveness. The auction house may be configured with an auction engine that is configured to operate auctions that allow the data consumers to bid for datasets to which exclusive access will be provided.

In some embodiments, access to the datasets may be non-exclusive. For example, access may be granted to any consumer that meets the criteria or the sharing policy, the top x bidders, based on a threshold criteria such as price, or the like or combination thereof.

In another example, a consortium of data consumers (e.g., a group of hospitals, universities, etc.) may apply under an umbrella grouping. Further, additional criteria for inclusion in the policies may include, in addition to cost, nonprofit research organization status, having IRB approval (approval from a university research body when research affects humans), or having organization accreditation/ratings by a trusted standards body. Depending on various regulations or subject matter or type of data, the government may limit or prevent datasets from being exclusive.

Embodiments of the invention may also provide suitable user interfaces that allow access to the users and the data consumers to directly and quickly interact with each other. This can facilitate the matching process and allow transactions to occur quickly.

Advantageously, embodiments of the invention do not rely on vendors to consolidate data from individuals and resellers. Embodiments empower users to store their own data on their own infrastructure. The prevents personal data from being sold or resold without the consent of the data owners—the users.

Personal data can be used for training on private infrastructure rather than being delivered to the data consumers. Thus, instead of transmitting personal data to data consumers (which might lead to loss of control), compute tasks from the data consumers can be executed on the infrastructure owned by individuals, so that personal data would never need to leave the premises of individuals.

In addition, the ability to have different levels of data exchange or sharing enable different purposes. Different levels can thus enable both research and marketing use cases for example. Both the users and data consumers can set up their own policies, which enables different levels of data sharing. For trusted data consumers, users might choose to share identity and contact information to receive marketing materials.

Next, the matching process can be automated. Alternatively, potential uses of the personal data can be automatically identified. This may be achieved, as previously described, based on policies, budgets, rewards, and the like or combination thereof.

For example, an increasing number of smart devices are monitoring our clothing choices, buying, and ad preferences, and much more personal information. While it is still common practice for each smart device or application to stream data back to their own data center, society is raising awareness and concerns on data privacy and ownership.

These smart devices or applications should stream data to privately-owned infrastructure, so that individuals can gain full control of their data. In this case, the fashion companies might have trouble gaining access to data. Embodiments of the invention can be utilized by fashion companies to obtain personal data, so that the individuals can also share their data for exchange of rewards. Embodiments of the invention, such as the examples disclosed herein, may be beneficial in a variety of respects. For example, and as will be apparent from the present disclosure, one or more embodiments of the invention may provide one or more advantageous and unexpected effects, in any combination, some examples of which are set forth below. It should be noted that such effects are neither intended, nor should be construed, to limit the scope of the claimed invention in any way. It should further be noted that nothing herein should be construed as constituting an essential or indispensable element of any invention or embodiment. Rather, various aspects of the disclosed embodiments may be combined in a variety of ways so as to define yet further embodiments. Such further embodiments are considered as being within the scope of this disclosure. As well, none of the embodiments embraced within the scope of this disclosure should be construed as resolving, or being limited to the resolution of, any particular problem(s). Nor should any such embodiments be construed to implement, or be limited to implementation of, any particular technical effect(s) or solution(s). Finally, it is not required that any embodiment implement any of the advantageous and unexpected effects disclosed herein.

The following is a discussion of aspects of example operating environments for various embodiments of the invention. This discussion is not intended to limit the scope of the invention, or the applicability of the embodiments, in any way.

In general, embodiments of the invention may be implemented in connection with systems, software, and components, that individually and/or collectively implement, and/or cause the implementation of, data platform operations. Such operations may include, but are not limited to, data control operations, data access operations, data store operations, or the like. More generally, the scope of the invention embraces any operating environment in which the disclosed concepts may be useful.

New and/or modified data collected and/or generated in connection with some embodiments, may be stored in a data protection environment that may take the form of a public or private cloud storage environment, an on-premises storage environment, and hybrid storage environments that include public and private elements or local and private infrastructure. Any of these example storage environments, may be partly, or completely, virtualized.

Example public cloud storage environments in connection with which embodiments of the invention may be employed include, but are not limited to, Microsoft Azure, Amazon AWS, and Google Cloud. More generally however, the scope of the invention is not limited to employment of any particular type or implementation of cloud storage.

In addition to the storage environment, the operating environment may also include one or more clients that are capable of collecting, modifying, and creating, data. As such, a particular client may employ, or otherwise be associated with, one or more instances of each of one or more applications that perform such operations with respect to data.

Devices in the operating environment may take the form of software, physical machines, or virtual machines (VM), or any combination of these, though no particular device implementation or configuration is required for any embodiment. Similarly, data protection system components such as databases, storage servers, storage volumes (LUNs), storage disks, replication services, backup servers, restore servers, backup clients, and restore clients, for example, may likewise take the form of software, physical machines or virtual machines (VM), though no particular component implementation is required for any embodiment. Where VMs are employed, a hypervisor or other virtual machine monitor (VMM) may be employed to create and control the VMs. The term VM embraces, but is not limited to, any virtualization, emulation, or other representation, of one or more computing system elements, such as computing system hardware. A VM may be based on one or more computer architectures, and provides the functionality of a physical computer. A VM implementation may comprise, or at least involve the use of, hardware and/or software. An image of a VM may take various forms, such as a .VMDK file for example.

As used herein, the term ‘data’ is intended to be broad in scope. Thus, that term embraces, by way of example and not limitation, data segments such as may be produced by data stream segmentation processes, data chunks, data blocks, atomic data, emails, objects of any type, files of any type including media files, word processing files, spreadsheet files, and database files, as well as contacts, directories, sub-directories, volumes, and any group of one or more of the foregoing.

Example embodiments of the invention are applicable to any system capable of storing and handling various types of objects, in analog, digital, or other form. Although terms such as document, file, segment, block, or object may be used by way of example, the principles of the disclosure are not limited to any particular form of representing and storing data or other information. Rather, such principles are equally applicable to any object capable of representing information.

Following are some further example embodiments of the invention. These are presented only by way of example and are not intended to limit the scope of the invention in any way.

Embodiment 1. A method, comprising: receiving data purchase policies from data consumers at an auction engine, receiving sharing policies and dataset metadata from users, matching a data consumer with a dataset of a user based on a data purchase policy of the data consumer and a sharing policy and dataset metadata associated with the dataset of the user, and sharing the dataset of the user when the matching is completed in accordance with the sharing policy associated with the dataset of the user.

Embodiment 2. The method of embodiment 1, further comprising providing the user with a reward associated with the sharing policy of the dataset.

Embodiment 3. The method of embodiment 1 and/or 2, wherein the sharing policy includes criteria specifying one or more of a reward selection, a sharing level, a length of authorization, a manner of execution, and reselling restrictions.

Embodiment 4. The method of embodiment 1, 2 and/or 3, wherein the metadata includes one or more of a size of the dataset, a category and format of the dataset, a description of an individual without identifying and contact information, an age of the dataset, an update date of the dataset, and a date range of the dataset.

Embodiment 5. The method of embodiment 1, 2, 3 and/or 4, wherein the data purchase policy includes criteria specifying one or more of a price per unit per database, a database category and format, a demographic, a minimum data length (e.g., in terms of time and/or data size), a budget, and a synchronization schedule.

Embodiment 6. The method of embodiment 1, 2, 3, 4, and/or 5, wherein matching a consumer with a dataset of a user includes matching criteria of the data purchase policy with the metadata and the sharing policy.

Embodiment 7. The method of embodiment 1, 2, 3, 4, 5, and/or 6, further comprising sharing the dataset by at least one of: executing an executable in a private infrastructure associated with the user and providing the data consumer with a result of the executable; sending the dataset to a third party infrastructure, executing an executable on the dataset in the third party infrastructure, and providing a result of the executable to the data consumer; or transmitting the dataset to the data consumer.

Embodiment 8. The method of embodiment 1, 2, 3, 4, 5, 6, and/or 7, further comprising listing the dataset at an online auction house, wherein the data consumers and users have access to the online auction house, wherein matches are determined automatically and datasets are shared in accordance with matches that are finalized.

Embodiment 9. The method of embodiment 1, 2, 3, 4, 5, 6, 7, and/or 8, further comprising auctioning the dataset such that one of the data consumers or a consortium of data consumers, has exclusive access to the dataset.

Embodiment 10. The method of embodiment 1, 2, 3, 4, 5, 6, 7, 8, and/or 9, further comprising verifying the data consumers and the users to prevent fraud.

Embodiment 11. The method as recited in any of embodiments 1-10 or portions thereof.

Embodiment 12. A non-transitory storage medium having stored therein instructions that are executable by one or more hardware processors to perform the operations of any one or more of embodiments or portions thereof of embodiments 1-11.

The embodiments disclosed herein thus include any combination of the embodiments disclosed herein or combinations thereof in part or in whole.

The embodiments disclosed herein may include the use of a special purpose or general-purpose computer including various computer hardware or software modules, as discussed in greater detail below. A computer may include a processor and computer storage media carrying instructions that, when executed by the processor and/or caused to be executed by the processor, perform any one or more of the methods disclosed herein, or any part(s) of any method disclosed.

As indicated above, embodiments within the scope of the present invention also include computer storage media, which are physical media for carrying or having computer-executable instructions or data structures stored thereon. Such computer storage media may be any available physical media that may be accessed by a general purpose or special purpose computer.

By way of example, and not limitation, such computer storage media may comprise hardware storage such as solid state disk/device (SSD), RAM, ROM, EEPROM, CD-ROM, flash memory, phase-change memory (“PCM”), or other optical disk storage, magnetic disk storage or other magnetic storage devices, or any other hardware storage devices which may be used to store program code in the form of computer-executable instructions or data structures, which may be accessed and executed by a general-purpose or special-purpose computer system to implement the disclosed functionality of the invention. Combinations of the above should also be included within the scope of computer storage media. Such media are also examples of non-transitory storage media, and non-transitory storage media also embraces cloud-based storage systems and structures, although the scope of the invention is not limited to these examples of non-transitory storage media.

Computer-executable instructions comprise, for example, instructions and data which, when executed, cause a general purpose computer, special purpose computer, or special purpose processing device to perform a certain function or group of functions. As such, some embodiments of the invention may be downloadable to one or more systems or devices, for example, from a website, mesh topology, or other source. As well, the scope of the invention embraces any hardware system or device that comprises an instance of an application that comprises the disclosed executable instructions.

Although the subject matter has been described in language specific to structural features and/or methodological acts, it is to be understood that the subject matter defined in the appended claims is not necessarily limited to the specific features or acts described above. Rather, the specific features and acts disclosed herein are disclosed as example forms of implementing the claims.

As used herein, the term ‘module’ or ‘component’ may refer to software objects or routines that execute on the computing system. The different components, modules, engines, and services described herein may be implemented as objects or processes that execute on the computing system, for example, as separate threads. While the system and methods described herein may be implemented in software, implementations in hardware or a combination of software and hardware are also possible and contemplated. In the present disclosure, a ‘computing entity’ may be any computing system as previously defined herein, or any module or combination of modules running on a computing system.

In at least some instances, a hardware processor is provided that is operable to carry out executable instructions for performing a method or process, such as the methods and processes disclosed herein. The hardware processor may or may not comprise an element of other hardware, such as the computing devices and systems disclosed herein.

In terms of computing environments, embodiments of the invention may be performed in client-server environments, whether network or local environments, or in any other suitable environment. Suitable operating environments for at least some embodiments of the invention include cloud computing environments where one or more of a client, server, or other machine may reside and operate in a cloud environment.

Any one or more of the entities disclosed, or implied, by the Figures and/or elsewhere herein, may take the form of, or include, or be implemented on, or hosted by, a physical computing device. As well, where any of the aforementioned elements comprise or consist of a virtual machine (VM), that VM may constitute a virtualization of any combination of the physical components disclosed herein.

In one example, the physical computing device includes a memory which may include one, some, or all, of random access memory (RAM), non-volatile random access memory (NVRAM), read-only memory (ROM), and persistent memory, one or more hardware processors, non-transitory storage media , UI device , and data storage . One or more of the memory components of the physical computing device may take the form of solid state device (SSD) storage. As well, one or more applications may be provided that comprise instructions executable by one or more hardware processors to perform any of the operations, or portions thereof, disclosed herein.

Such executable instructions may take various forms including, for example, instructions executable to perform any method or portion thereof disclosed herein, and/or executable by/at any of a storage site, whether on-premises at an enterprise, or a cloud storage site, client, datacenter, or backup server, to perform any of the functions disclosed herein. As well, such instructions may be executable to perform any of the other operations and methods, and any portions thereof, disclosed herein.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method, comprising:
receiving data purchase policies from data consumers at an auction engine;
receiving sharing policies and dataset metadata from users;
matching a data consumer with a dataset of a user based on a data purchase policy of the data consumer and a sharing policy and dataset metadata associated with the dataset of the user; and
sharing the dataset of the user when the matching is completed in accordance with the sharing policy associated with the dataset of the user.

2. The method of claim 1, further comprising providing the user with a reward associated with the sharing policy of the dataset.

3. The method of claim 1, wherein the sharing policy includes criteria specifying one or more of a reward selection, a sharing level, a length of authorization, a manner of execution, and reselling restrictions.

4. The method of claim 3, wherein the metadata includes one or more of a size of the dataset, a category and format of the dataset, a description of an individual without identifying and contact information, an age of the dataset, an update date of the dataset, and a date range of the dataset.

5. The method of claim 3, wherein the data purchase policy includes criteria specifying one or more of a price per unit per database, a database category and format, a demographic, a minimum data length, a budget, and a synchronization schedule, wherein the minimum data length relates to time and/or data size.

6. The method of claim 1, wherein matching a consumer with a dataset of a user includes matching criteria of the data purchase policy with the metadata and the sharing policy.

7. The method of claim 1, further comprising sharing the dataset by at least one of:
executing an executable in a private infrastructure associated with the user and providing the data consumer with a result of the executable;
sending the dataset to a third party infrastructure, executing an executable on the dataset in the third party infrastructure, and providing a result of the executable to the data consumer; or
transmitting the dataset to the data consumer.

8. The method of claim 1, further comprising listing the dataset at an online auction house, wherein the data consumers and users have access to the online auction house, wherein matches are determined automatically and datasets are shared in accordance with matches that are finalized.

9. The method of claim 1, further comprising auctioning the dataset such that one of the data consumers or a consortium of data consumers has exclusive access to the dataset.

10. The method of claim 1, further comprising verifying the data consumers and the users to prevent fraud.

11. A non-transitory storage medium having stored therein instructions that are executable by one or more hardware processors to perform operations comprising:
receiving data purchase policies from data consumers at an auction engine;
receiving sharing policies and dataset metadata from users;
matching a data consumer with a dataset of a user based on a data purchase policy of the data consumer and a sharing policy and dataset metadata associated with the dataset of the user; and
sharing the dataset of the user when the matching is completed in accordance with the sharing policy associated with the dataset of the user.

12. The non-transitory storage medium of claim 11, the instructions further comprising providing the user with a reward associated with the sharing policy of the dataset.

13. The non-transitory storage medium of claim 11, wherein the sharing policy includes criteria specifying one or more of a reward selection, a sharing level, a length of authorization, a manner of execution, and reselling restrictions.

14. The non-transitory storage medium of claim 13, wherein the metadata includes one or more of a size of the dataset, a category and format of the dataset, a description of an individual without identifying and contact information, an age of the dataset, an update date of the dataset, and a date range of the dataset.

15. The non-transitory storage medium of claim 13, wherein the data purchase policy includes criteria specifying one or more of a price per unit per database, a database category and format, a demographic, a minimum data length, a budget, and a synchronization schedule, wherein the minimum data length relates to time and/or data size.

16. The non-transitory storage medium of claim 11, wherein matching a consumer with a dataset of a user includes matching criteria of the data purchase policy with the metadata and the sharing policy.

17. The non-transitory storage medium of claim 11, the operations further comprising sharing the dataset by at least one of:
executing an executable in a private infrastructure associated with the user and providing the data consumer with a result of the executable;
sending the dataset to a third party infrastructure, executing an executable on the dataset in the third party infrastructure, and providing a result of the executable to the data consumer; or
transmitting the dataset to the data consumer.

18. The non-transitory storage medium of claim 11, the operations further comprising listing the dataset at an online auction house, wherein the data consumers and users have access to the online auction house, wherein matches are determined automatically and datasets are shared in accordance with matches that are finalized.

19. The non-transitory storage medium of claim 11, the operations further comprising auctioning the dataset such that one of the data consumers or a consortium of data consumers has exclusive access to the dataset.

20. The non-transitory storage medium of claim 11, the operations further comprising verifying the data consumers and the users to prevent fraud.
